(19) United States
(12) Patent Application Publication
(10) Pub. No.: US 2008/0267067 A1
(43) Pub. Date: Oct. 30, 2008

(54) CONTROLLING THE FLOW OF DATA UPDATES BETWEEN A RECEIVING STATION AND A SENDING STATION

(76) Inventors: Gabriel Salazar, Fort Collins, CO (US); Roy L. Troutman, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,552

(22) Filed: Apr. 30, 2007

(51) Int. Cl. G08C 15/00

(52) U.S. Cl. 370/235

(57) ABSTRACT

Methods and systems for controlling the flow of data updates between a receiving station and a sending station are described herein. At least some illustrative embodiments comprise a method that comprises determining (by a sending station) whether a trigger event has occurred, and transmitting a data update to a receiving station if the trigger event occurred and if a time elapsed since a transmission time of a previous data update exceeds a minimum threshold time period.

### BACKGROUND

With the proliferation of high speed networks and Internet access, an increasing number of corporate entities now provide their employees with remote access to corporate computers. This enables employees to work from home or other locations during normal working hours (sometimes referred to as telecommuting), as well as after-hours and on weekends. Such remote access to computer resources is provided by a variety of software packages, such as, for example, Remote Desktop Client interacting with Terminal Services, both by Microsoft®. These and other similar software packages can provide access to a collection of terminal sessions and virtual computers selected from a pool, or access to specific individual computers. Users log into a “remote session” wherein the user's desktop appears as the desktop would appear if the user were logged in locally to an actual, distinct computer.

When a user establishes a remote session, video from the remote computer is sent to the user's workstation in the form of messages transmitted across an intervening network such as the Internet. These messages are sent at a rate that enables the user's workstation to display the information at the frame rate it would have been displayed at a display coupled locally to the remote computer (e.g., 30 frames per second). The messages comprise the video data to be displayed at the user's workstation, and may be in either compressed or uncompressed form. But even when compressed, the amount of data being transmitted can exceed the bandwidth available on the network, either because of network constraints or excessive traffic already present on the network. As a result, applications providing data from the remote computer to the user's workstation may suffer performance degradations, causing other processing activities, such as keyboard and mouse input or audio streaming, to become less interactive and sporadically interrupted. If the data is streaming video data, frames may be missed and not displayed at the user's workstation.

### BRIEF DESCRIPTION OF THE DRAWINGS

For a detailed description of exemplary embodiments of the invention, reference will now be made to the accompanying drawings in which:

FIG. 1 shows a system comprising a receiving station and a sending station, configured to operate in accordance with at least some illustrative embodiments;

FIG. 2A shows an example of a system configuration, suitable for use as either the receiving station or the sending station of FIG. 1, in accordance with at least some illustrative embodiments;

FIG. 2B shows a block diagram of the system configuration of FIG. 2A, in accordance with at least some illustrative embodiments; and

FIGS. 3A, 3B and 3C show variations of a method implementing a data update control algorithm, each in accordance with at least some illustrative embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Additionally, the term “system” refers to a collection of two or more hardware and/or software components, and may be used to refer to an electronic device, such as a computer, a portion of a computer, a combination of computers, etc. Further, the term “software” includes any executable code capable of running on a processor, regardless of the medium used to store the software. Thus, code stored in non-volatile memory, and sometimes referred to as “embedded firmware,” is included within the definition of software.

### DETAILED DESCRIPTION

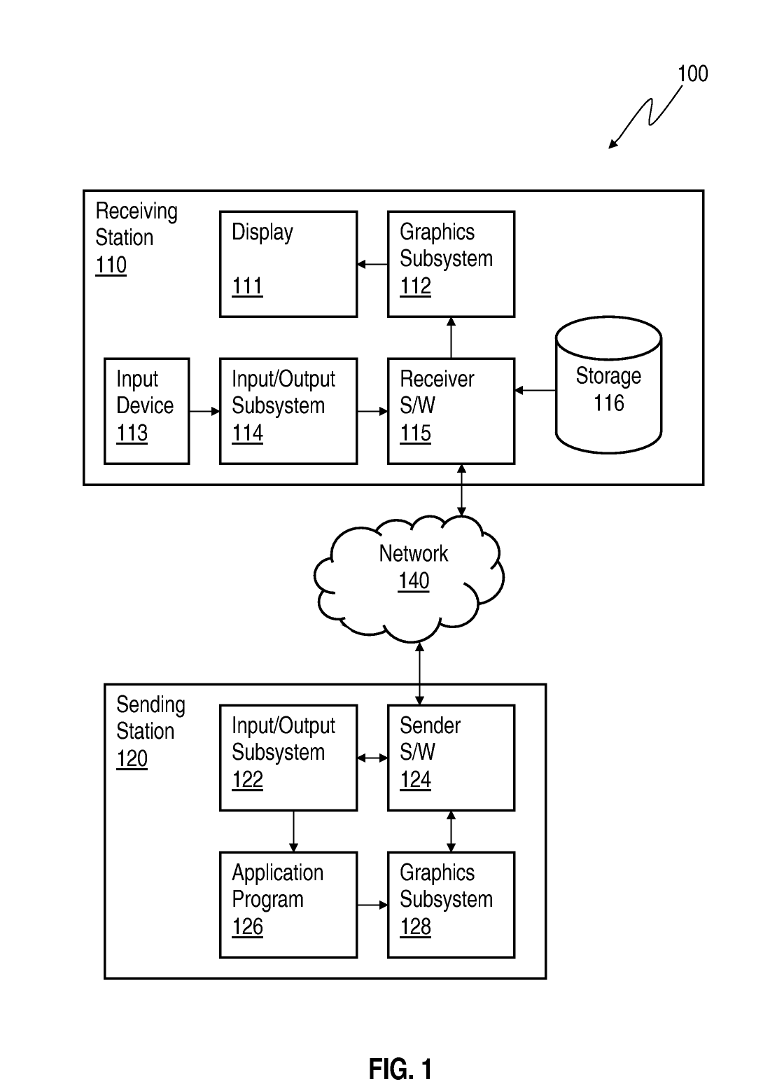

FIG. 1 shows a computer system 100, in accordance with at least some illustrative embodiments, in which a receiving station 110 interacts with a sending station 120. Receiving station 110 and sending station 120 couple to each other via a network 140, such as, for example, the Internet. Receiving station 110 comprises logic that provides some or all of the functionality of receiving station 110. The logic of receiving station 110 may comprise software executing on a processor (e.g., receiver software 115 as shown in FIG. 1), dedicated or programmable digital hardware, or a combination of both software and hardware.

Receiving station 110 also comprises graphics subsystem 112 and display 111, which provide graphical images to a user of receiving station 110; input/output subsystem 114 and input device 113 which receive input data from the user; and storage device 116, which may be used to store at least some configuration information used by receiver software 115. Receiver software (Receiver S/W) 115 receives messages from sending station 120. The messages comprise video data that is forwarded to graphics subsystem 112, which displays the information to the user via display 111. The user provides input via input device 113, which is forwarded by input/output subsystem 114 to receiver software 115. Receiver software 115 subsequently sends one or more messages to sending station 120 comprising the input data received from input/output subsystem 114. The input data comprises data originated from input device 113, which in at least some embodiments includes a keyboard and mouse.

Continuing to refer to the illustrative embodiment of FIG. 1, sending station 120 comprises sender software (Sender S/W) 124 and application program 126, each comprising executable code executing on sending station 120. Sender software 124 provides some or all of the functionality of sending station 120. Sending station 120 also comprises input/output subsystem 122 and graphics subsystem 128. Sender software 124 receives messages from receiving station 110 with input data originated by the user operating receiving station 110 (via input device 113). The input data is forwarded to application program 126 via input/output subsystem 122. Graphical data generated by application program 126 is sent to graphics subsystem 128, which forwards the graphical data to sender software 124. Sender software formats the graphical data into messages that are transmitted to receiving station 110, which displays the data to the user as previously described.

Sender software 124 and receiver software 115 together act as an abstraction layer that hides the existence of the underlying network from both the user operating receiver station 110 and application program 126 executing on sending station 120. By hiding the underlying network, the user interacts with application 126 as if it were executing locally on receiving station 110, and application 126 interacts with the user as if the user were directly operating sending station 120 via locally-coupled devices. This infrastructure enables for the creation of one or more “remote access sessions,” which in at least some illustrative embodiments is referred to as a “remote visualization session,” and in other illustrative embodiments is referred to as a “remote graphics session.” A remote access, visualization or graphics session is a process by which two computers, a receiving station that initiates the session and a sending station that hosts the session, interact to provide a user at the receiving station with a computing environment that appears to the user as if the user were logged directly into the sending station.

The host sending station provides graphical information to the receiving station as described above, which displays the images represented by the information as the images would be displayed at the sending station if the user were logged-in locally to the sending station. The graphical information comprises sequential bits of data, grouped to represent pixels displayed on a display. The data is transmitted in the time-sequenced order in which the pixels are drawn on a display (e.g., left to right for each pixel within a scan line, and top to bottom for each scan line in sequence). Likewise, the user operates the receiving station, which provides input data (e.g., keyboard characters and mouse coordinate data) to the sending station, and the input data is received and processed by the sending station in the same manner as inputs provided by a locally logged-in user.

As shown in FIG. 1, the data exchanged between sending station 120 and receiving station 110 passes through network 140. This network may comprise any number of different sub-networks, each operating at different data transfer rates, and each experiencing differing levels of bandwidth utilization. As a result, the overall end-to-end bandwidth available for transferring data between sending station 120 and receiving station 110 may be limited. In order for sending station 120 to provide an uninterrupted stream of graphical data without exceeding the bandwidth limitations of the intervening network, the rate at which graphical data is transferred from sending station 120 to receiving station 110 is restricted to a predetermined maximum limit or maximum update rate.

The update rate represents the frequency at which sending station 120 provides to receiving station 110 data that represents a single displayed frame of graphical information. In at least some illustrative embodiments the update rate is limited using a combination of several mechanisms: 1) by providing video data upon request from receiving station 110; 2) by providing video data when the sender detects changes to the video data; and by combining either 1 and 2 with 3) limiting the rate at which sending station 120 responds to both update requests and video data changes to no more than a pre-configured maximum number of updates per unit time (e.g., no more than 5 updates sent to the receiving station per second, or no more than 1 update every 200 milliseconds). By using a trigger event to initiate an update, and by further limiting the update rate to a pre-configure maximum, the sending station can prevent a large number of graphical data updates from being sent to receiving station 110. Such a large number of updates could require bandwidth in excess of the available bandwidth of network 140, or data transfer and processing capabilities at either sending station 120 or receiving station 110 in excess of the capabilities of one or both of the stations. In at least some illustrative embodiments, this maximum update rate is imposed, regardless of the number of changes to the graphical data at sending station 120, or the number of pending requests from the receiving station 110.

In at least some illustrative embodiments, the update rate is configured at sending station 120 by a system administrator and saved (either in volatile or non-volatile storage) for later use by sender software 124 to limit the rate at which graphical data is sent to receiving station 110. The maximum update rate allowed is selected by the system administrator, taking into account such factors as the overall bandwidth of network 140 between sending station 120 and receiving station 110, as well as processing limitations such as the number of frames that can be sent, received, and processed per second by both sending station 120 and receiving station 110. Such processing limitations can include internal data transfer limitations of each station, limitations on the throughput of network interfaces within each station, and limitations on the ability of graphical processors within each station to compress and/or decompress video data before and after transmission of the graphical data across network 140.

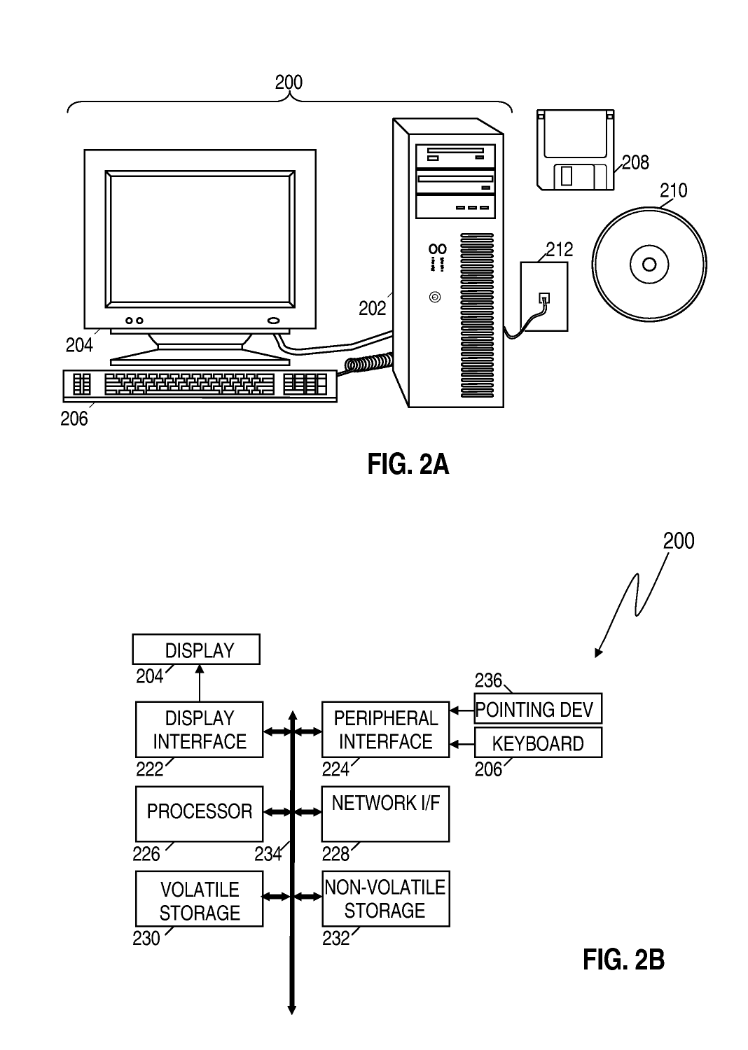

FIGS. 2A and 2B show an illustrative system configuration 200 suitable for implementing receiving station 110 and sending station 120 of FIG. 1. As shown, the illustrative system configuration 200 comprises a chassis 202, a display 204, and an input device 206. The system configuration 200 comprises a processor 226, volatile storage 230, and non-volatile storage 232. Volatile storage 230 comprises a computer-readable medium such as random access memory (RAM). Non-volatile storage 232 comprises a computer-readable medium such as flash RAM, read-only memory (ROM), a hard disk drive, a floppy disk (e.g., floppy 208), a compact disk read-only memory (CD-ROM, e.g., CD 210), and combinations thereof.

The computer-readable media of both volatile storage 230 and non-volatile storage 232 comprise, for example, software that is executed by processor 226 and provides both receiving station 110 and sending station 120 with some or all of the functionality described herein. The system configuration 200 also comprises a network interface 228 that enables the system configuration 200 to receive information via a local area network and/or a wired or wireless wide area network, represented in the example of FIG. 2A by Ethernet jack 212. A display interface 222 couples to the display 204. A user interacts with the station via the input device 206 and/or pointing device (Pointing Dev) 236 (e.g., a mouse), which couples to a peripheral interface 224. The display 204, together with the input device 206 and/or the pointing device 236, may operate together as a user interface.

System 200 may be a bus-based computer, with the bus 234 interconnecting the various elements shown in FIG. 2B. The peripheral interface 224 accepts signals from the keyboard 206 and other input devices such as a pointing device 236, and transforms the signals into a form suitable for communication on the bus 234. The display interface 222 may comprise a video card or other suitable display interface that accepts information from the bus 234 and transforms it into a form suitable for the display 204.

The processor 226 gathers information from other system elements, including input data from the peripheral interface 224, and program instructions and other data from non-volatile storage 232 or volatile storage 230, or from other systems (e.g., a server used to store and distribute copies of executable code) coupled to a local area network or a wide area network via the network interface 228. The processor 226 executes the program instructions and processes the data accordingly. The program instructions may further configure the processor 226 to send data to other system elements, such as information presented to the user via the display interface 222 and the display 204. The network interface 228 enables the processor 226 to communicate with other systems via a network (e.g., network 140 of FIG. 1). Volatile storage 230 may serve as a low-latency temporary store of information for the processor 226, and non-volatile storage 232 may serve as a long term (but higher latency) store of information.

The processor 226, and hence the system configuration 200 as a whole, operates in accordance with one or more programs stored on non-volatile storage 232 or received via the network interface 228. The processor 226 may copy portions of the programs into volatile storage 230 for faster access, and may switch between programs or carry out additional programs in response to user actuation of the input device. The additional programs may be retrieved from non-volatile storage 232 or may be retrieved or received from other locations via the network interface 228. One or more of these programs executes on system configuration 200 causing the configuration to perform at least some of the receiving and sending functions of receiving station 110 and sending station 120, respectively, as disclosed herein.

Although a fully equipped computer system is shown in the illustrative embodiment of FIGS. 2A and 2B, other embodiments comprise fewer options and may be suitable as the receiving station 110. At least some embodiments of receiving station 110 comprise only some of the hardware features shown in FIGS. 2A and 2B, and only execute the software necessary to establish a remote session. Such embodiments of the receiving station 110 are referred to as a “thin” client. Similarly, at least some embodiments of sending station 120 comprise only some of the hardware features shown in FIGS. 2A and 2B. For example, if sending station 120 is used exclusively as a remote host, keyboard 206, pointing device 236, and display 204 are not needed. Other embodiments of the receiving and sending stations, with various combinations of hardware features and installed software, will become apparent to those skilled in the art, and all such embodiments of the receiving and sending stations are intended to be within the scope of the present disclosure.

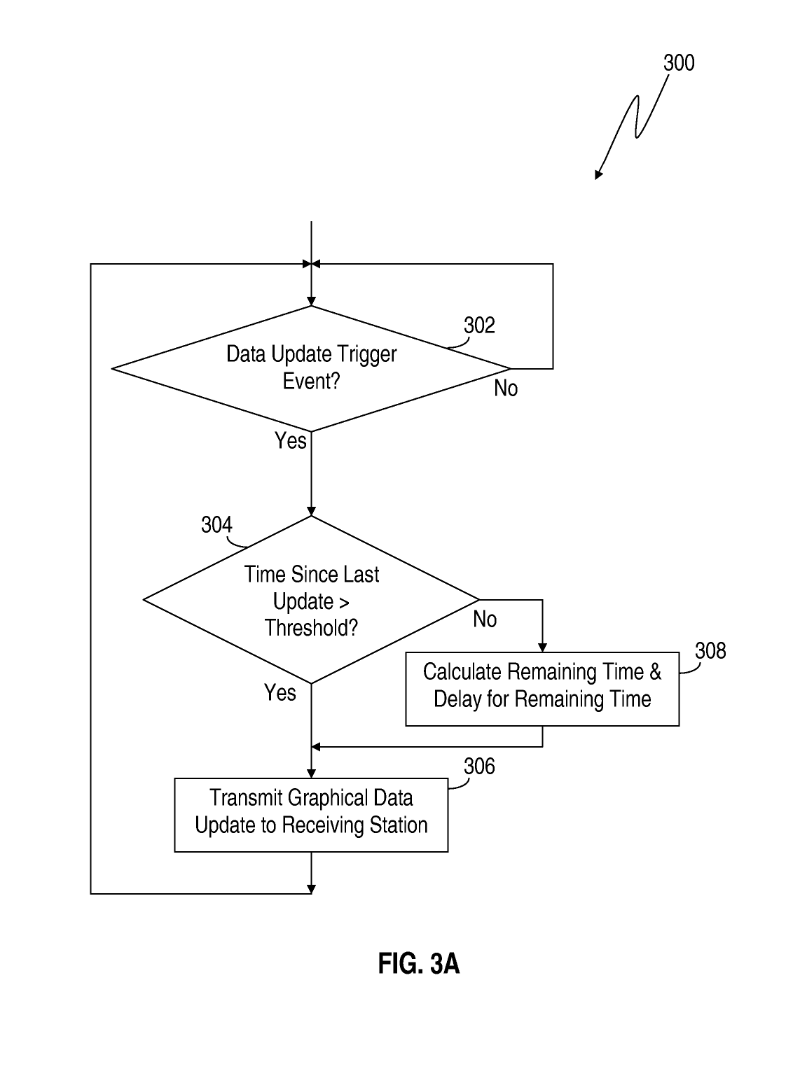

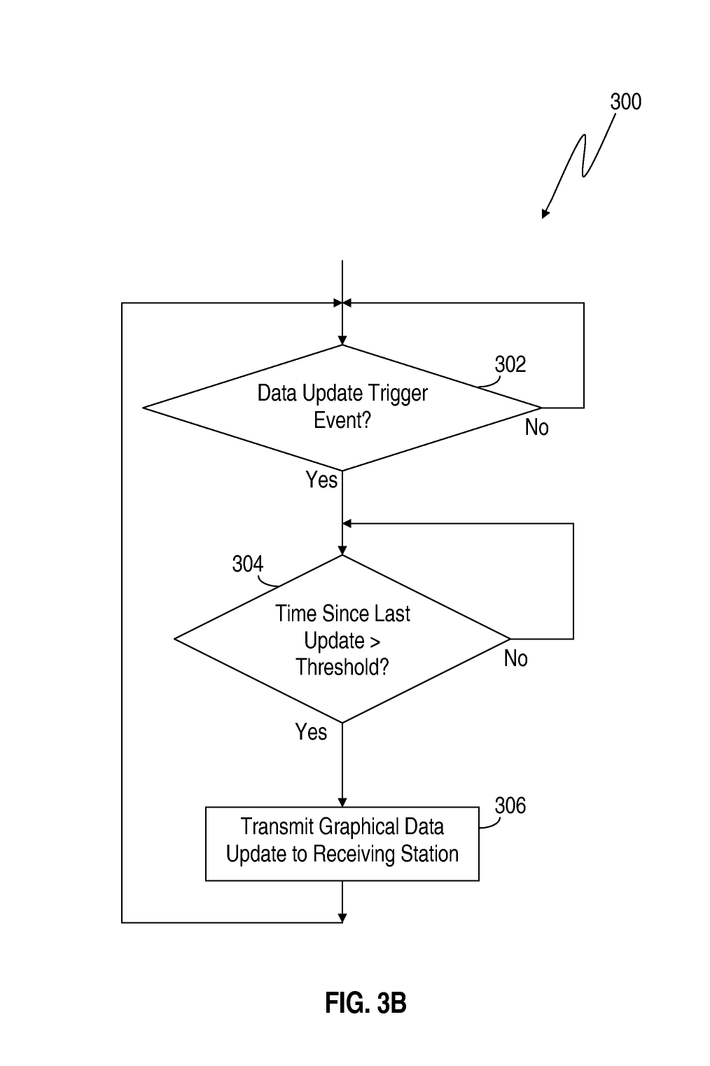

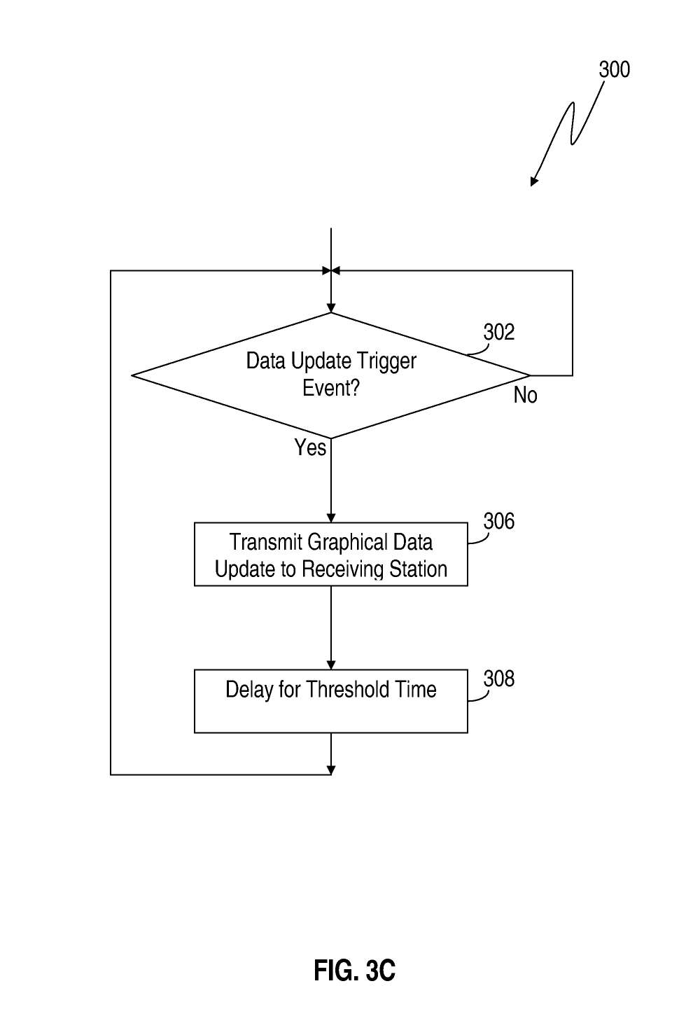

FIGS. 3A, 3B and 3C each shows an illustrative embodiment of a method 300 suitable for limiting a graphical data update rate, in accordance with at least some illustrative embodiments. The order of the actions can be changed from that shown, and one or more actions can be combined together or performed in parallel (concurrently). Referring to both FIGS. 1 and 3A, sender software 124, executing on sending station 120, executes a wait loop until a graphical data update trigger event occurs (block 302). In at least some illustrative embodiments, such a trigger event comprises whether graphical data maintained on sending station 120 by application program 126 has changed, and whether a graphical data update request from receiving station 110 is pending. Other trigger events that may be utilized to implement method 300 will become apparent to those skilled in the art, and all such trigger events are within the scope of the present disclosure.

When a trigger event occurs (block 302), sender software 124 checks if the time that has elapsed since the last graphical data update was sent to receiving station 110 exceeds a minimum threshold time period (block 304). In at least some illustrative embodiments this threshold equals the inverse of the maximum graphical update rate allowed. As one illustrative example, the threshold check may be performed by comparing the threshold to the difference between the current time as maintained by a real-time clock within sending station 120 and a saved time tag (representing the time of transmission of the last display update). Other techniques for determining and comparing elapsed times are well known in the art, and all such techniques are within the scope of the present disclosure.

If the time that has elapsed since the last graphical data update was sent to receiving station 110 is greater than the threshold (block 304), a graphical data update is transmitted to the receiving station (block 306), and the method 300 repeats. The graphical data update may comprise one or more messages, depending on the amount of data sent in a single update and the maximum packet size allowed on network 140. In at least some illustrative embodiments, the time of transmission of the graphical data update of block 306 is saved for later use in the time threshold check of block 304 as described above. If the time that has elapsed since the last update is not greater than the threshold (block 304), the time remaining before the threshold is reached is calculated, and a delay equal to the time remaining is executed (block 308). The time remaining may be calculated, for example, by summing the threshold time period to the time of transmission of the last graphical update, and subtracting the current time from the resulting summation. In at least some illustrative embodiments, the desired delay is achieved utilizing a “sleep” function, wherein a software program implementing the method 300 suspends execution for a fixed period of time (e.g., the remaining time calculated in block 308). Upon expiration of the delay period, a display update is transmitted to the receiving station (block 306), and the method 300 repeats.

As described above, the embodiment of FIG. 3A utilizes a delay if the elapsed time does not exceed the threshold to enforce a maximum update rate. In the illustrative embodiment of FIG. 3B, the calculated delay of block 308 (FIG. 3A) is eliminated and replaced by a wait loop implemented as part of block 304. After determining that an update trigger event has occurred (block 302), the wail loop is executed until the time since the last response to an update trigger event exceeds the threshold (block 304). Upon exceeding the threshold, a graphical data update is transmitted to the receiving station (block 306), and method 300 repeats.

In the illustrative embodiment of FIG. 3C, the threshold check of block 304 (FIG. 3A) is eliminated. Upon detecting an update trigger event (block 302), a graphical data update is sent to the receiving station (block 306). After the data is transmitted, a fixed delay equal to the threshold value is executed (block 308), and method 300 repeats. In this manner updates are forced to occur at a rate no higher than the maximum update rate (i.e., spaced out by a time period no less than the minimum threshold time period). Other techniques for measuring and enforcing a minimum threshold time between updates, thus limiting graphical updates to a maximum update rate, will become apparent to those of ordinary skill in the art, and all such technique are within the scope of the present disclosure.

The above discussion is meant to be illustrative of the principles and various embodiments of the present invention. Numerous variations and modifications will become apparent to those skilled in the art once the above disclosure is fully appreciated. For example, although the embodiments of the present disclosure are shown and described in the context of graphical data updates within a system that facilitates remote sessions, other embodiments that provide updates of other types of isochronous data and other types of computing systems are also within the scope of the present disclosure. It is intended that the following claims be interpreted to embrace all such variations and modifications.

What is claimed is:

1. A method, comprising:
determining, by a sending station, whether a trigger event has occurred; and
transmitting a data update to a receiving station if the trigger event occurred and if a time elapsed since a transmission time of a previous data update exceeds a minimum threshold time period.

2. The method of claim 1, further comprising calculating a remaining time and waiting until the remaining time elapses before transmitting the data update, if the time elapsed since the transmission time of the previous data update does not exceed the minimum threshold time period.

3. The method of claim 2, further comprising calculating the remaining time by summing the minimum threshold time period to the transmission time of the previous data update, and subtracting a current time from the resulting summation.

4. The method of claim 1, wherein the trigger event comprises detecting a pending request from the receiving station for a data update.

5. The method of claim 1, wherein the trigger event comprises detecting that data to be sent to the receiving station has changed since the previous data update transmission.

6. The method of claim 1, wherein the data update transmitted to the receiving station comprises graphical data transmitted as a transaction within a remote graphics session.

7. A system, comprising
a network interface configured to receive a data update request from a receiving station; and
logic that processes a received request and generates a data update message;
wherein the logic determines whether a trigger event has occurred; and
wherein the logic causes the network interface to transmit the data update message if the trigger event has occurred and if a time elapsed since a transmission time of a previous data update message transmission is greater than a minimum threshold time period.

8. The system of claim 7, wherein the logic calculates a remaining time and waits until the remaining time elapses before transmitting the data update message, if the time elapsed since the transmission time of the previous data update message does not exceed the minimum threshold time period.

9. The system of claim 8, wherein the logic calculates the remaining time by summing the minimum threshold time period to the transmission time of the previous data update, and subtracting a current time from the resulting summation.

10. The system of claim 7, wherein the trigger event comprises at least one event selected from the group consisting of detecting a pending data update request from the receiving station, and detecting that data to be sent to the receiving station has changed since the previous data update message transmission.

11. The system of claim 7, wherein the logic comprises a processor executing software.

12. The system of claim 7, wherein the data update message generated by the logic comprises graphical data transmitted as a transaction within a remote graphics session.

13. A computer-readable medium comprising software that causes a processor to:
determine whether a trigger event has occurred; and
transmit a data update to a receiving station if the trigger event occurred and if a time elapsed since a transmission time of a previous data update exceeds a minimum threshold time period.

14. The computer-readable medium of claim 13, wherein the software further cause the processor to calculate a remaining time and wait until the remaining time elapses before transmitting the data update, if the time elapsed since the transmission time of the previous data update does not exceed the minimum threshold time period.

15. The computer-readable medium of claim 14, wherein the software further cause the processor to calculate the remaining time by summing the minimum threshold time period to the transmission time of the previous data update, and subtracting a current time from the resulting summation.

16. The computer-readable medium of claim 13, wherein the trigger event comprises at least one event selected from the group consisting of the software detecting a pending request from the receiving station for a data update, and the software detecting that data to be sent to the receiving station has changed since the previous data update transmission.

17. The computer-readable medium of claim 13, wherein the data update transmitted to the receiving station comprises graphical data transmitted as a transaction within a remote graphics session.

18. A method, comprising:
determining whether a trigger event has occurred;
transmitting a data update to a receiving station if the trigger event occurred; and
waiting for at least a minimum threshold time period before repeating the determining of whether the trigger event has occurred.

19. The method of claim 18, wherein the trigger event comprises detecting a pending request from the receiving station for a data update.

20. The method of claim 18, wherein the trigger event comprises detecting that data to be sent to the receiving station has changed since the previous data update transmission.

21. The method of claim 18, wherein the data update transmitted to the receiving station comprises graphical data transmitted as a transaction within a remote graphics session.

22. A computer-readable medium comprising software that causes a processor to:
determine whether a trigger event has occurred;
transmit a data update to a receiving station if the trigger event occurred; and
wait for at least a minimum threshold time period before causing the processor to again determine whether the trigger event has occurred.

23. The computer-readable medium of claim 22, wherein the trigger event comprises at least one event selected from the group consisting of the software detecting a pending request from the receiving station for a data update, and the software detecting that data to be sent to the receiving station has changed since the previous data update transmission.

24. The computer-readable medium of claim 22, wherein the data update transmitted to the receiving station comprises graphical data transmitted as a transaction within a remote graphics session.
